(19) United States
(12) Patent Application Publication
(10) Pub. No.: US 2003/0116340 A1
(43) Pub. Date: Jun. 26, 2003

(54) Receptacle structure

(76) Inventor: Tung-Liang Li, Tainan (TW)

Correspondence Address: Alan D. Kamrath, Rider, Bennett, Egan & Arundel, LLP, 333 South Seventh Street, Suite 2000, Minneapolis, MN, 55402, US

(21) Appl. No.: 10/345,737

(22) Filed: Jan. 16, 2003

Related U.S. Application Data
(63) Continuation-in-part of application No. 10/028,783, filed on Dec. 21, 2001.

(51) Int. Cl. H01H 9/02

(52) U.S. Cl. 174/53

(57) ABSTRACT

A receptacle structure includes a receptacle that uses the electric wires to function as the transmission media of the electric power and the internet. The receptacle has an inside provided with an electric wire transmission module that makes the receptacle function as a connection head of the internet and the interface of the internet. The receptacle includes a USB port connected to a PC so as to function as an interface of the internet. The receptacle further includes a phone port connected to a telephone set so as to provide a function of a telephone.

### CROSS-REFERENCES TO RELATED APPLICATIONS

The present invention is a continuation-in-part application of the co-pending U.S. Ser. No. 10/028,783, filed on Dec. 21, 2001, now abandoned.

### BACKGROUND OF THE INVENTION

1. Field of the Invention

The present invention relates to a receptacle structure, and more particularly to a receptacle structure, wherein the receptacle can integrate the plug of the electrical appliance and the connection head of the internet, and can use the electric wires to function as the transmission media of the electric power and the internet.

2. Description of the Related Art

A conventional receptacle allows insertion of the plug of an electrical appliance, so that the electric power is transferred by the electric wires into the electric appliance. On the other hand, the data of the internet are transferred by the telephone wires or the cables. Thus, the electric power of the appliance and the data of the internet are transmitted by different transmission wires, so that many wires are provided in the room or office and are easily tangled with each other, thereby causing confusion, disturbance and convenience to the user.

### SUMMARY OF THE INVENTION

The present invention has arisen to mitigate and/or obviate the disadvantage of the conventional transmission manner of the electric power and the internet.

The primary objective of the present invention is to provide a receptacle structure, wherein the receptacle can integrate the plug of the electrical appliance and the connection head of the internet, and can use the electric wires to function as the transmission media.

Another objective of the present invention is to provide a receptacle structure, wherein when the receptacle is used in the internet, the receptacle can function as the connection head of the internet or the interface of the internet.

A further objective of the present invention is to provide a receptacle structure, wherein when the receptacle is used in the telephone set, the receptacle can be used to connect the telephone set.

A further objective of the present invention is to provide a receptacle structure, wherein the main frame can be used to control the electric power of the receptacle.

A further objective of the present invention is to provide a receptacle structure, wherein the remote receiving module (RF or IF) can be used for control of the internet.

A further objective of the present invention is to provide a receptacle structure, wherein the high speed USB port and ETH port of the receptacle are connected to the PC so as to function as an interface of the internet.

A further objective of the present invention is to provide a receptacle structure, wherein the receptacle can integrate the high/low speed electric wire internet, and can use the electric wires to function as the transmission media.

In accordance with the present invention, there is provided a receptacle structure, comprising a receptacle, wherein:

the receptacle uses electric wires to function as transmission media of an electric power and an internet, the receptacle has an inside provided with an electric wire transmission module, the electric wire transmission module makes the receptacle function as a connection head of the internet and the interface of the internet, the receptacle includes a USB port connected to a PC so as to function as an interface of the internet, the receptacle further includes a phone port connected to a telephone set so as to provide a function of a telephone.

Thus, the receptacle can integrate the electric wires and the internet wires. In addition, the receptacle allows insertion of the plug of the electrical appliance and the connection head of the internet.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of a receptacle structure in accordance with a preferred embodiment of the present invention.

### DETAILED DESCRIPTION OF THE INVENTION

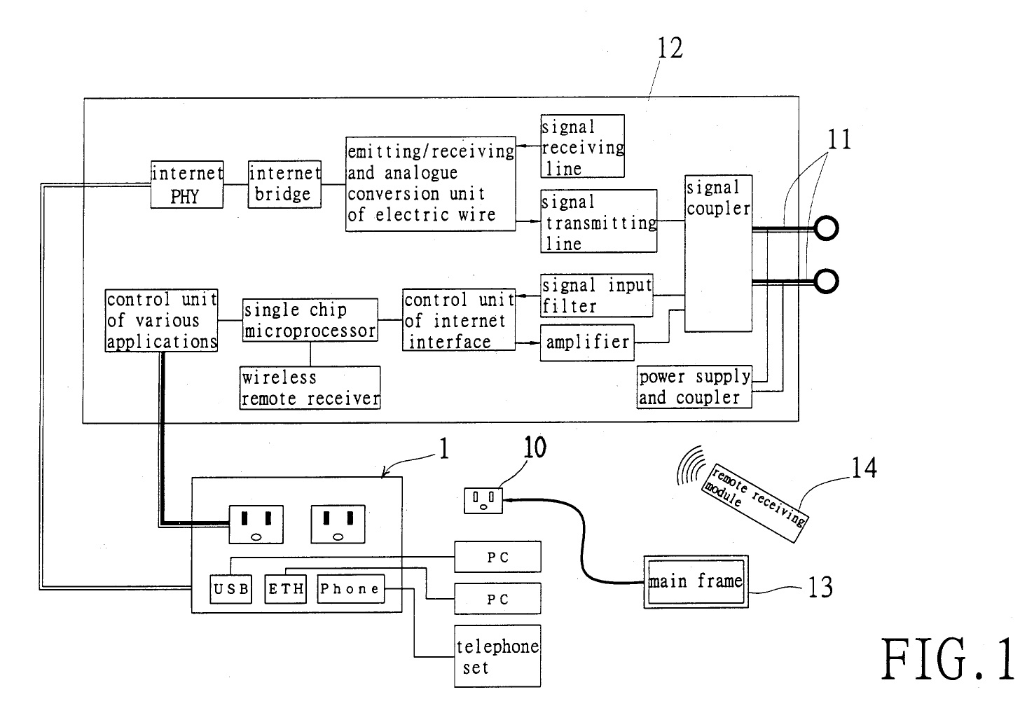

Referring to FIG. 1, a receptacle structure in accordance with a preferred embodiment of the present invention comprises a receptacle 1.

The receptacle 1 uses electric wires 11 to function as the transmission media of the electric power and the internet. The transmission of the electric wires I 1 is proceeded by an electric wire carrier wave so as to transfer the data. The receptacle 1 has an inside provided with an electric wire transmission module 12. The electric wire transmission module 12 makes the receptacle 1 function as a connection head of the internet and the interface of the internet. The power switch 10 of the receptacle 1 is controller by a main frame 13. The receptacle structure further comprises a remote receiving module 14 that is used for control of the internet. The receptacle 1 includes a high speed USB port and ETH port connected to a PC so as to function as an interface of the internet. The receptacle 1 further includes a phone port connected to a telephone set so as to provide the function of the telephone.

Accordingly, the receptacle structure in accordance with the preferred embodiment of the present invention has the following advantages.

1. The receptacle 1 can integrate the plug of the electrical appliance and the connection head of the internet, and can use the electric wires 11 to function as the transmission media.

2. When the receptacle 1 is used in the internet, the receptacle 1 can function as the connection head of the internet or the interface of the internet.

3. When the receptacle 1 is used in the telephone set, the receptacle 1 can be used to connect the telephone set.

4. The main frame 13 can be used to control the electric power of the receptacle 1.

5. The remote receiving module 14 (RF or IF),can be used for control of the internet.

6. The high speed USB port and ETH port of the receptacle 1 are connected to the PC so as to function as an interface of the internet.

7. The receptacle 1 can integrate the high/low speed electric wire internet, and can use the electric wires 11 to function as the transmission media.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A receptacle structure, comprising a receptacle, wherein:
the receptacle uses electric wires to function as transmission media of an electric power and an internet, the receptacle has an inside provided with an electric wire transmission module, the electric wire transmission module makes the receptacle function as a connection head of the internet and the interface of the internet, the receptacle includes a USB port connected to a PC so as to function as an interface of the internet, the receptacle further includes a phone port connected to a telephone set so as to provide a function of a telephone.

2. The receptacle structure in accordance with claim 1, further comprising a main frame for controlling a power switch of the receptacle.

3. The receptacle structure in accordance with claim 1, further comprising a remote receiving module that is used for control of the internet.

4. The receptacle structure in accordance with claim 1, wherein a transmission of the electric wires is proceeded by an electric wire carrier wave so as to transfer the data.
